(19) United States
(12) Patent Application Publication
(10) Pub. No.: US 2012/0305468 A1
(43) Pub. Date: Dec. 6, 2012

(54) WATER TREATMENT APPARATUS

(75) Inventors: Shigeru Sato, Tokyo (JP); Yoshiaki Obune, Tokyo (JP)

(73) Assignee: KURITA WATER INDUSTRIES LTD., Tokyo (JP)

(21) Appl. No.: 13/577,921

(22) PCT Filed: Mar. 30, 2011
(86) PCT No.: PCT/JP2011/058003

§ 371 Date: Aug. 9, 2012

(30) Foreign Application Priority Data
Mar. 30, 2010 (JP) 2010-079591

(51) Int. Cl. C02F 1/52; B01D 21/01

(52) U.S. Cl. 210/295

(57) ABSTRACT

A water treatment apparatus includes: a mixing element having a mixing tank in which water is mixed with a flocculant added thereto; a flocculation element having a cylindrical flocculation tank into which the water discharged from the mixing element is introduced, and in which the water is kept unexposed to the atmosphere, a for-treatment water inlet which introduces the water to be treated into the flocculation tank from a lower part of the flocculation tank in a tangential direction so as to produce a swirl flow, and a for-treatment water outlet discharging the water to be treated from the upper part of the flocculation tank; and a solid-liquid separation element into which the water to be treated after discharge from the flocculation element is introduced from the flocculation element without being exposed to the atmosphere, and in which the water to be treated is subjected to solid-liquid separation.

### TECHNICAL FIELD

This invention relates to a water treatment apparatus which adds a flocculant to water to be treated, such as industrial water, city water, well water, river water, lake water or industrial waste water, for flocculation, and then performs solid-liquid separation such as filtration or membrane separation.

### BACKGROUND ART

Methods for treating water to be treated, such as industrial water, city water, well water, river water, lake water or industrial waste water, include methods which comprise, for example, adding an inorganic flocculant and a polymer flocculant of anionic nature or the like to the water to be treated, thereby performing flocculation to adsorb or coagulate suspended matter or the like contained in the water to be treated, followed by carrying out solid-liquid separation, such as sand filtration, dissolved air floatation, filtration using a fibrous filter (filter medium), or membrane separation, to remove the suspended matter (see Patent Documents 1 to 3).

With flocculation, however, a flocculation tank of an open type, namely, one in which the water to be treated is exposed to the atmosphere, is generally used for coarsening flocculated matter (flocs). A liquid feeding means, such as a pump, is necessary when feeding the water to be treated to an apparatus in a subsequent stage which performs solid-liquid separation. The flocs are destroyed by the pump or the like, posing the problem that clear treated water is difficult to obtain.

Patent Document 4 describes closed type flocculation in which water to be treated is held without being exposed to the atmosphere. With this Patent Document 4, however, an apparatus for stirring in an open type flocculation tank basically having a stirrer is provided in a stage succeeding a flocculation means, so that the destruction of flocs by a pump or the like may occur.

### PRIOR ART DOCUMENTS

### Patent Documents

Patent Document 1: JP-A-2003-265907
Patent Document 2: JP-A-2004-89766
Patent Document 3: JP-A-2007-229638
Patent Document 4: JP-A-2004-160353

### SUMMARY OF THE INVENTION

### Problems to be Solved by the Invention

The present invention has been accomplished in the light of the above-mentioned circumstances. It is an object of the invention to provide a water treatment apparatus which performs solid-liquid separation after flocculation, and which can reliably obtain clear treated water.

### Means for Solving the Problems

An aspect of the present invention, designed to solve the above-mentioned problems, lies in a water treatment apparatus comprising: mixing means having a mixing tank in which water to be treated is mixed with a flocculant added thereto to form flocs; flocculation means having a cylindrical flocculation tank into which the water to be treated after discharge from the mixing means is introduced, and in which the water to be treated is kept unexposed to the atmosphere, a for-treatment water inlet which introduces the water to be treated into the flocculation tank from a lower part of the flocculation tank in a tangential direction so as to produce a swirl flow, and a for-treatment water outlet, provided in an upper part of the flocculation tank, for discharging the water to be treated from the upper part of the flocculation tank; and solid-liquid separation means into which the water to be treated after discharge from the flocculation means is introduced from the flocculation means without being exposed to the atmosphere, and in which the water to be treated is subjected to solid-liquid separation.

The for-treatment water outlet may be provided so as to discharge the water to be treated from the upper part of the flocculation tank in a tangential direction.

The solid-liquid separation means is preferably filtration means comprising a filter charged into a filtration tank such that the void content of a filtration portion during water passage becomes 50 to 95%, the filter having string-shaped suspended matter trapping portions.

Preferably, the mixing means keeps the water to be treated in such a state as not to be exposed to the atmosphere, the water to be treated is introduced from the mixing means into the flocculation means without being exposed to the atmosphere, and liquid feeding means for feeding the water to be treated is provided in a stage preceding the mixing means.

### Effects of the Invention

The water treatment apparatus is configured to have the mixing means for mixing the flocculant and the water to be treated to form flocs such as suspended matter; the flocculation means for introducing the mixed water to be treated into the cylindrical flocculation tank, where the water to be treated is kept unexposed to the atmosphere, so as to produce a swirl flow, thereby coarsening the flocs; and the solid-liquid separation means into which the flocculated water to be treated is introduced, without being exposed to the atmosphere, whereby it is subjected to solid-liquid separation. Because of this configuration, coarse flocs formed by the flocculation means can be conveyed to the solid-liquid separation means in the subsequent stage without the use of a liquid feeding means such as a pump. As a result, the destruction of the coarse flocs can be suppressed. Thus, the water treatment apparatus enables clear treated water to be obtained.

### BRIEF DESCRIPTION OF THE DRAWINGS

FIG. 1 is a schematic system diagram of an example of a water treatment apparatus.

FIGS. 2(a) and 2(b) are a top view and a side view, respectively, showing the configuration of a flocculation means.

FIG. 3 is a schematic view of a mixing means and the flocculation means.

FIGS. 4(a) to 4(f) are top views, side views and schematic views showing other configuration examples of the flocculation means.

FIG. 5 is a schematic view of a water treatment apparatus.

FIG. 6 is a schematic view of another water treatment apparatus.

FIG. 7 is a schematic view of still another water treatment apparatus.

FIG. 8 is a sectional view showing the configuration of a filtration apparatus.

FIG. 9 is an enlarged view of essential parts of the filtration apparatus.

FIG. 10 is a view showing an example of a suspended matter trapping portion of the filtration apparatus.

FIG. 11 is a schematic system diagram of a water treatment apparatus.

### MODE FOR CARRYING OUT THE INVENTION

The water treatment apparatus of the present invention is a water treatment apparatus in which a flocculant is added to water to be treated, thereby flocculating the water, and then solid-liquid separation, such as sedimentation, dissolved air floatation, filtration or membrane separation, is carried out.

Examples of the water to be treated are water containing humic acid-based or fulvic acid-based organic substances, water containing biological metabolites such as sugars produced by algae, etc., and water containing synthetic chemical substances such as surface active agents. Concrete examples are industrial water, city water, well water, river water, lake water, and industrial waste water (particularly, bioremediation water resulting after bioremediation of waste water from factories). However, they are not limitative. Humus refers to humic substances occurring upon degradation of plants, etc. by microorganisms, and includes humic acid and so on. Water containing humus has humus and/or humus-derived soluble COD components, suspended matter, or chromatic components.

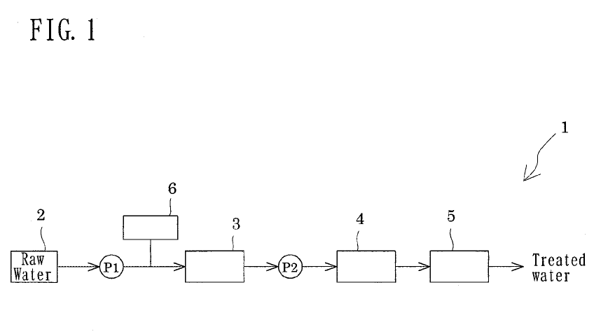

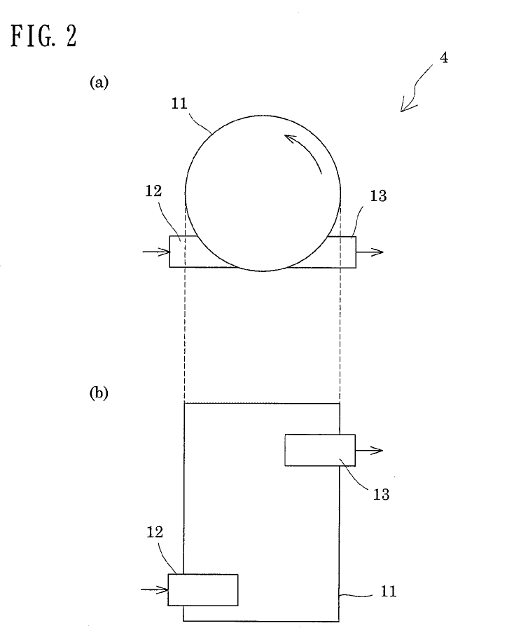

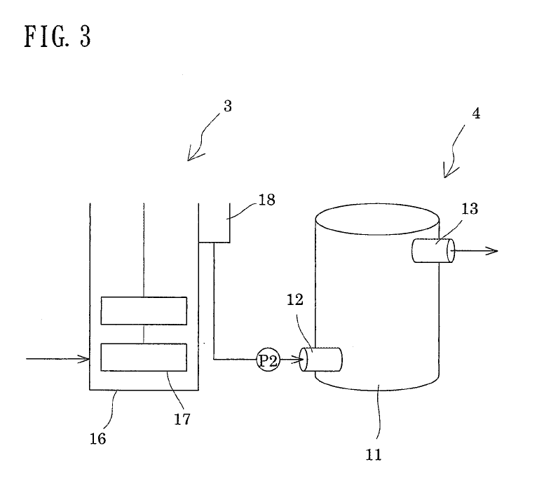

Using FIGS. 1 to 3 illustrating an example of a water treatment apparatus according to the present invention, the water treatment apparatus of the present invention will be described in detail. FIG. 1 is a schematic system diagram of the water treatment apparatus. FIGS. 2(a) and 2(b) are a top view of a flocculation means which the water treatment apparatus has (FIG. 2(a)) and a side view of the flocculation means (FIG. 2(b)). FIG. 3 shows a mixing means and the flocculation means which the water treatment apparatus has.

As shown in FIG. 1, a water treatment apparatus 1 of the present invention comprises: a mixing means 3 having a mixing tank in which water to be treated (raw water) is mixed with a flocculant added thereto to form flocs; a flocculation means 4 into which the water to be treated after discharge from the mixing means 3 is introduced; and a solid-liquid separation means 5 in which the water to be treated after discharge from the flocculation means 4 is subjected to solid-liquid separation. Moreover, a flocculant introduction means 6 for adding the flocculant to the water to be treated is provided in a stage preceding the mixing means 3. There are no limitations on the flocculant, and the flocculant may be any one which can, for example, coagulate or flocculate suspended matter, colloidal components, soluble COD (chemical oxygen demand) components, etc. contained in the water to be treated, thereby forming flocs (flocculated matter). Examples of the flocculant are inorganic flocculants such as aluminum salts including polyaluminum chloride (PAC) and iron salts; polymer flocculants; and particles comprising cationic polymers which swell in water and substantially do not dissolve in water, such as ACCOGEL C, a cationic polymer gel produced by MT AquaPolymer, Inc. These flocculants can be used alone or in combination.

As shown in FIG. 1, moreover, a pump P1 is provided in the stage preceding the mixing means 3, and a pump P2 is provided between the mixing means 3 and the flocculation means 4, as a liquid feeding means for feeding the water to be treated. The flocculation means 4 and the solid-liquid separation means 5 are connected by piping, as shown by an arrow in FIG. 1, in such a manner that the water to be treated is passed without being exposed to the atmosphere. The state “without being exposed to the atmosphere” or the state of being unexposed to the atmosphere refers to a state in which the feeding pressure (the pressure for feeding the water to be treated) of the pump 2 or the like provided in the stage preceding the flocculation means 4 can be maintained, namely, a closed state where the feeding pressure minimally escapes to the atmosphere.

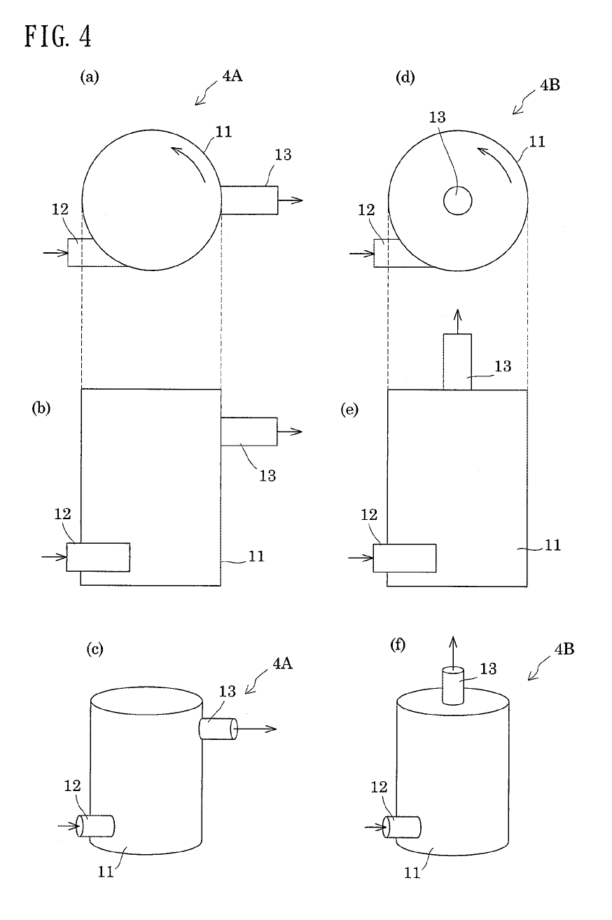

The flocculation means 4, as shown in FIGS. 2(a) and 2(b), is furnished with a cylindrical flocculation tank 11 into which the water to be treated is introduced; a for-treatment water inlet 12 which introduces the water to be treated (may be herein referred to as for-treatment water) into the flocculation tank 11 from a lower part of the flocculation tank 11 in a tangential direction so as to produce a swirl flow as indicated by an arrow; and a for-treatment water outlet 13 for discharging the water to be treated from an upper part of the flocculation tank 11 in a tangential direction. Since the for-treatment water inlet 12 is provided in the lower part of the flocculation tank 11 and the for-treatment water outlet 13 is provided in the upper part of the flocculation tank 11, the swirl flow produced is an upward flow. Furthermore, the flocculation tank 11 is in a shape in which a cylinder having a hollow interior is covered with lids at its top surface and its bottom surface, and the introduced water to be treated is kept in a state unexposed to the atmosphere. That is, the flocculation tank 11 is of a closed type. In FIGS. 1 to 3, the flocculation means 4 is described as one having the for-treatment water outlet 13 for discharging the water to be treated from the upper part of the flocculation tank 11 in the tangential direction. However, the for-treatment water outlet 13 may be any one which is provided in the upper part of the flocculation tank 11 and can discharge the water to be treated from the upper part of the flocculation tank 11. As shown in FIGS. 4(a) to 4(c), for example, the flocculation means may be flocculation means 4A having the for-treatment water outlet 13 provided on an upper side surface of the flocculation tank 11 without extending in the tangential direction. Alternatively, the flocculation means may be flocculation means 4B having the for-treatment water outlet 13 at the top of the flocculation tank 11, as shown in FIGS. 4(d) to 4(f). FIG. 4(a) is a top view of the flocculation means 4A, FIG. 4(b) is a side view of the flocculation means 4A, FIG. 4(c) is a schematic view of the flocculation means 4A, FIG. 4(d) is a top view of the flocculation means 4B, FIG. 4(e) is a side view of the flocculation means 4B, and FIG. 4(f) is a schematic view of the flocculation means 4B.

The size of the flocculation tank 11 is not limited, but its inner diameter may be of the order of 2 m as the upper limit, and inner diameter:height may be of the order of 1 to 5:3 to 10. Nor is any limitation imposed on the position where the for-treatment water inlet 12 or the for-treatment water outlet 13 is provided. However, the central position of a cross section in the water passage direction of the for-treatment water inlet 12 may, for example, be within the radius of the for-treatment water inlet 12 plus 2 m upwardly from the bottom of the flocculation tank 11, while the central position of a cross section in the water passage direction of the for-treatment water outlet 13 may, for example, be within the radius of the for-treatment water outlet 13 plus 2 m downwardly from the ceiling of the flocculation tank 11. Nor are there any limitations on the amount of water passage, the dwell time, or the G-value, of the water to be treated. However, the amount of water passage of the water to be treated may, for example, be such that the initial flow velocity (flow velocity at the for-treatment water inlet) is 0.5 to 2.0 [m/s]. The dwell time may, for example, be 0.1 to 10 minutes, preferably 2 to 5 minutes, and the average G-value of the flocculation tank may, for example, be 20 to 200 [m/s].

The mixing means 3, for example, has a mixing tank 16 introducing the water to be treated and having an open top, a rapid stirrer 17 for stirring the water to be treated to mix the flocculant and the water to be treated, and a temporary storage tank 18 for temporarily storing the mixed water to be treated, as shown in FIG. 3.

The solid-liquid separation means 5 is not limited, as long as it can carry out solid-liquid separation for removing flocs including suspended matter, such as sedimentation, dissolved air floatation, filtration or membrane separation. In the present embodiment, however, the solid-liquid separation means 5 is a filtration apparatus 20 having string-shaped (fibrous) filter elements for trapping flocs formed from the flocculant and the suspended matter or the like contained in the water to be treated (details of the filtration apparatus will be described later). The sedimentation or dissolved air floatation can be performed, because pH adjustment using caustic soda, slaked lime or sulfuric acid is made in adding the flocculant to the water to be treated, and the suspended materials are finally converted into flocs with the use of an organic polymer flocculant. If desired, an organic coagulant may be used concurrently. Examples of the membrane for membrane separation are a microfiltration membrane (MF membrane), an ultrafiltration membrane (UF membrane), a nano-filtration membrane (NF membrane), and a reverse osmosis membrane (RO membrane).

With the water treatment apparatus 1 configured as above, the flocculant is introduced by the flocculant introduction means 6 into piping, through which the water to be treated (raw water) that has been stored in a raw water tank 2 is passed, to add the flocculant to the water to be treated. The water to be treated which has the flocculant added thereto is introduced into the mixing tank 16 of the mixing means 3, and is stirred by the stirrer 17 relatively rapidly to mix the water to be treated and the flocculant. By this treatment, suspended matter or the like contained in the water to be treated and the flocculant form flocs. Then, the water to be treated which has flocks formed therein is stored in the temporary storage tank 18. The water to be treated which has been stored in the temporary storage tank 18 is fed by the pump P2, and is introduced into the lower part of the flocculation tank 11 through the for-treatment water inlet 12 provided in the lower part of the flocculation tank 11 of the flocculation means 4 in the tangential direction. When the water to be treated is so introduced into the for-treatment water inlet 12 provided in the tangential direction in the lower part of the flocculation tank 11, a swirl flow as indicated by an arrow in FIG. 2(a) is produced. By this swirl flow, the flocs formed by the mixing means 3 are stirred relatively gently and coarsened, whereafter they arrive at the for-treatment water outlet 13 while ascending, and are then discharged through the for-treatment water outlet 13. This treatment for coarsening the flocs is called flocculation. In the present embodiment, the flocculation tank 11 does not have other members, such as partition plates, inner tubes or stirrers, in its inside, and thus has nothing impeding the swirl flow of the water to be treated. Hence, the flocs can be prevented from becoming fine upon collision with the members, for example, and the flocs can be coarsened satisfactorily. Since the flocculation tank 11 has no members inside, it goes without saying that its maintenance is easy, and its manufacturing cost and operating cost can also be kept down. In the case of water passage in a downward flow, a short pass takes place, thus worsening the efficiency of flocculation. Water passage in the horizontal direction results in a nonuniform flow of water, and may destroy the flocs. In the case of an upward flow, as in the present embodiment, the water surface uniformly ascends throughout the flocculation tank 11, so that stirring is stable, and floc coarsening can be performed efficiently. Moreover, the flocculation tank 11 is of a cylindrical shape covered at the top surface and the bottom surface. Thus, the introduced water to be treated is not exposed to the atmosphere and, consequently, the feeding pressure of the pump P2 is maintained even in the water to be treated which is discharged from the for-treatment water outlet 13.

The water to be treated which has been discharged from the for-treatment water outlet 13 after flocculation is passed through piping connecting the for-treatment water outlet 13 and the solid-liquid separation means 5. As described above, the feeding pressure of the pump P2 is maintained even in the water to be treated which is discharged from the for-treatment water outlet 13. Furthermore, the piping is provided from the flocculation means 4 up to the solid-liquid separation means 5 such that the water to be treated is passed without being exposed to the atmosphere. That is, the for-treatment water outlet 13 of the flocculation means 4 and the inlet for introducing the water to be treated into the solid-liquid separation means 5 are connected by the piping. Even if a liquid feeding means, such as a pump, for passing the water to be treated to the solid-liquid separation means 5 is not provided between the flocculation means 4 and the solid-liquid separation means 5, therefore, the water to be treated is fed to the solid-liquid separation means 5. In this manner, the destruction of the coarsened flocs by a liquid feeding means such as a pump can be prevented. Hence, the flocs can be removed satisfactorily by the solid-liquid separation means 5, and clear treated water can be obtained reliably.

There may be a case in which a liquid feeding means, such as a pump, for passing the water to be treated to the solid-liquid separation means 5 needs to be provided between the flocculation means 4 and the solid-liquid separation means 5. With a water treatment apparatus in which the top of the flocculation tank of the flocculation means is open and the water to be treated is exposed to the atmosphere, or with a water treatment apparatus in which the water to be treated becomes exposed to the atmosphere in a region from the flocculation means to the solid-liquid separation means, for example, the use of the liquid feeding means such as a pump results in the destruction of the flocks, which have been coarsened by flocculation, to very small sizes. The flocs so destroyed cannot be removed satisfactorily by the solid-liquid separation means in the subsequent stage, and clear treated water is difficult to obtain. If an apparatus for relatively rapid stirring by a stirrer or the like after flocculation is provided, the flocks are destroyed, making it similarly difficult to obtain clear treated water.

The example shown in FIG. 1 illustrates the water treatment apparatus 1 in which the water to be treated is unexposed to the atmosphere in the flocculation means 4 itself and in the route of liquid feeding between the flocculation means 4 and the solid-liquid separation means 5. However, there may further be a water treatment apparatus in which the mixing means 3 is also structured to keep the water to be treated unexposed to the atmosphere, so that the water to be treated is introduced from the mixing means 3 into the flocculation means 4 without being exposed to the atmosphere.

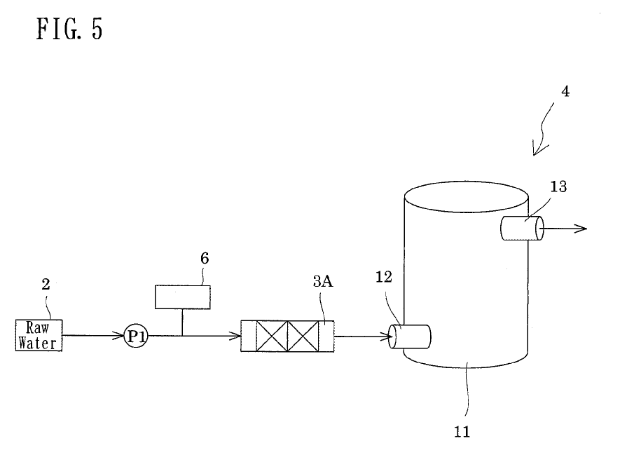

Concretely, as shown in FIG. 5, a water treatment apparatus has a raw water tank 2 storing water to be treated (raw water), a mixing means 3A, a flocculation means 4 for introducing the water to be treated which has been discharged from the mixing means 3A, and a solid-liquid separation means (not shown) for performing the solid-liquid separation of the water to be treated which has been discharged from the flocculation means 4. Also, a flocculant introduction means 6 for adding a flocculant to the water to be treated is provided in a stage preceding the mixing means 3A. The same apparatuses as those in FIGS. 1 to 3 are assigned the same numerals as in FIGS. 1 to 3, and explanations for the same apparatuses, etc. are omitted.

In the water treatment apparatus shown in FIG. 5, the mixing means 3A comprises two line mixers connected in series, in which the water to be treated is held unexposed to the atmosphere. Needless to say, the number of the line mixers is not limited. The mixing means 3A, the flocculation means 4, and the solid-liquid separation means are connected in this sequence by piping, and the water to be treated is passed, without being exposed to the atmosphere, from the mixing means 3A as far as the solid-liquid separation means via the flocculation means 4. Thus, the feeding pressure of a pump P1 provided in a stage preceding the mixing means 3A is maintained from the mixing means 3A until the solid-liquid separation means. Hence, the liquid feeding means may be only the pump P1 provided in the stage preceding the mixing means 3A. As a result, costs and maintenance involved in the provision of a plurality of pumps can be cut down. From the viewpoint of smallness of the installation area, the line mixer is preferred. However, mixing may be performed, for example, by line mixing, with the piping being extended to prolong the dwell time.

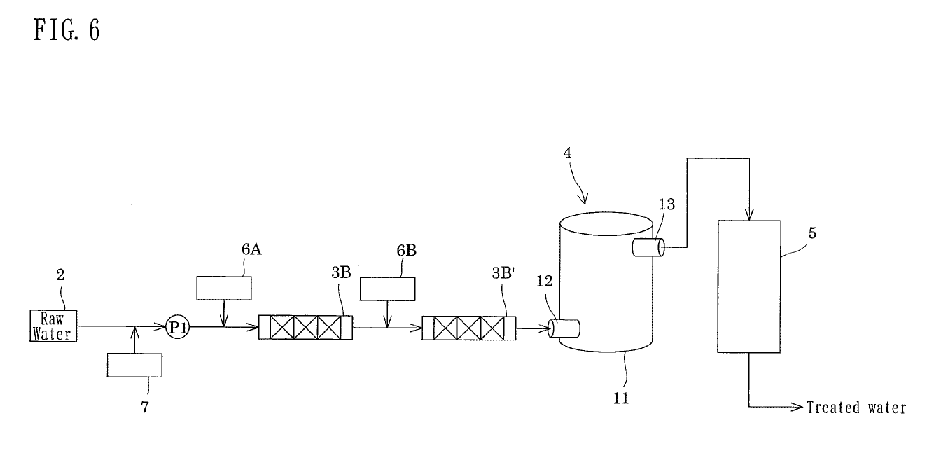

In the above-mentioned example, the flocculant is added to the water to be treated before being introduced into the mixing means 3. However, the flocculant may be added to the mixing means 3 into which the water to be treated has been introduced, namely, the mixing tank 16. Moreover, a plurality of mixing tanks or line mixers may be provided, and different types of flocculants may be added for the respective mixing tanks or line mixers. A water treatment apparatus configured to add different types of flocculants for different line mixers, that is, to pass water through a line mixer each time a different type of flocculant is added, will be described using FIG. 6.

As shown in FIG. 6, the water treatment apparatus has a raw water tank 2 storing water to be treated (raw water), a mixing means 3B, a mixing means 3B′ for introducing the water to be treated which has been discharged from the mixing means 3B, a flocculation means 4 for introducing the water to be treated which has been discharged from the mixing means 3B′, and a solid-liquid separation means 5 for performing the solid-liquid separation of the water to be treated which has been discharged from the flocculation means 4. Also, an inorganic flocculant introduction means 6A for adding an inorganic flocculant to the water to be treated is provided in a stage preceding the mixing means 3B. Moreover, a polymer flocculant introduction means 6B for adding a polymer flocculant to the water to be treated is provided in a stage preceding the mixing means 3B′. A pH adjustor introduction means 7 for introducing a pH adjustor into the water to be treated is provided upstream of the mixing means 3B. The same apparatuses as those in FIGS. 1 to 5 are assigned the same numerals as in FIGS. 1 to 5, and explanations for the same apparatuses, etc. are omitted.

In the water treatment apparatus shown in FIG. 6, the mixing means 3B and the mixing means 3B′ have the same structure comprising three line mixers connected in series, in which the water to be treated is held unexposed to the atmosphere. Needless to say, the number of the line mixers is not limited. The mixing means 3B, the mixing means 3B′, the flocculation means 4, and the solid-liquid separation means 5 are connected in this sequence by piping, and the water to be treated is passed, without being exposed to the atmosphere, from the mixing means 3B as far as the solid-liquid separation means 5 via the mixing means 3B′ and the flocculation means 4. Thus, the feeding pressure of a pump P1 provided in a stage preceding the mixing means 3B is maintained from the mixing means 3B until the solid-liquid separation means 5. Hence, the liquid feeding means may be only the pump P1 provided in the stage preceding the mixing means 3B. As a result, costs and maintenance involved in the provision of a plurality of pumps can be cut down. After the water to be treated is treated by the mixing means 3B after addition of the inorganic flocculant, the water is treated by the mixing means 3B′ after addition of the polymer flocculant which is a flocculant of a different type. Thus, flocs are formed from the inorganic flocculant, suspended matter, and soluble COD components, and even larger flocs are formed from these flocs and the polymer flocculant, whereafter they are coarsened by a swirl flow.

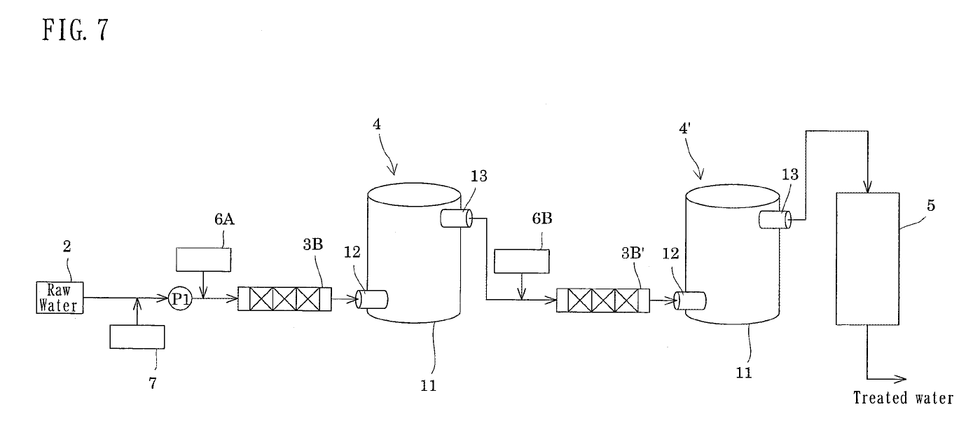

There may be constructed a water treatment apparatus in which each time a flocculant of a different type is added, water is passed through a line mixer and flocculation means 4 in this order. Such a water treatment apparatus, as shown in FIG. 7, has a raw water tank 2 storing water to be treated (raw water), a mixing means 3B, a flocculation means 4 for introducing the water to be treated which has been discharged from the mixing means 3B, a mixing means 3B′ for introducing the water to be treated which has been discharged from the flocculation means 4, a flocculation means 4′ for introducing the water to be treated which has been discharged from the mixing means 3B′, and a solid-liquid separation means 5 for performing the solid-liquid separation of the water to be treated which has been discharged from the flocculation means 4′. In FIG. 7, the flocculation means 4 and the flocculation means 4′ are of the same structure. An inorganic flocculant introduction means 6A for adding an inorganic flocculant to the water to be treated is provided in a stage preceding the mixing means 3B. Also, a polymer flocculant introduction means 6B for adding a polymer flocculant to the water to be treated is provided in a stage preceding the mixing means 3B′. A pH adjustor introduction means 7 for introducing a pH adjustor into the water to be treated is provided upstream of the mixing means 3B. The same apparatuses as those in FIGS. 1 to 6 are assigned the same numerals as in FIGS. 1 to 6, and explanations for the same apparatuses, etc. are omitted.

In the water treatment apparatus shown in FIG. 7, the mixing means 3B and the mixing means 3B′ are of the same structure comprising three line mixers connected in series, in which the water to be treated is held unexposed to the atmosphere. Needless to say, the number of the line mixers is not limited. The mixing means 3B, the flocculation means 4, the mixing means 3B′, the flocculation means 4′, and the solid-liquid separation means 5 are connected in this sequence by piping, and the water to be treated is passed, without being exposed to the atmosphere, from the mixing means 3B as far as the solid-liquid separation means 5 via the flocculation means 4, the mixing means 3B′ and the flocculation means 4′. Thus, the feeding pressure of a pump P1 provided in a stage preceding the mixing means 3B is maintained from the mixing means 3B until the solid-liquid separation means 5. Hence, the liquid feeding means may be only the pump P1 provided in the stage preceding the mixing means 3B. As a result, costs and maintenance involved in the provision of a plurality of pumps can be cut down. According to this configuration, the water to be treated which has the inorganic flocculant added thereto is treated by the mixing means 3B and the flocculation means 4 in this order. Then, the water to be treated to which the polymer flocculant, a different type of flocculant, has been added is treated by the mixing means 3B′ and the flocculation means 4′ in this order. Thus, flocs are formed from the inorganic flocculant, suspended matter, soluble COD components, etc., and coarsened by a swirl flow. Then, even larger flocs are formed from these coarsened flocs and the polymer flocculant, whereafter they are coarsened by a swirl flow.

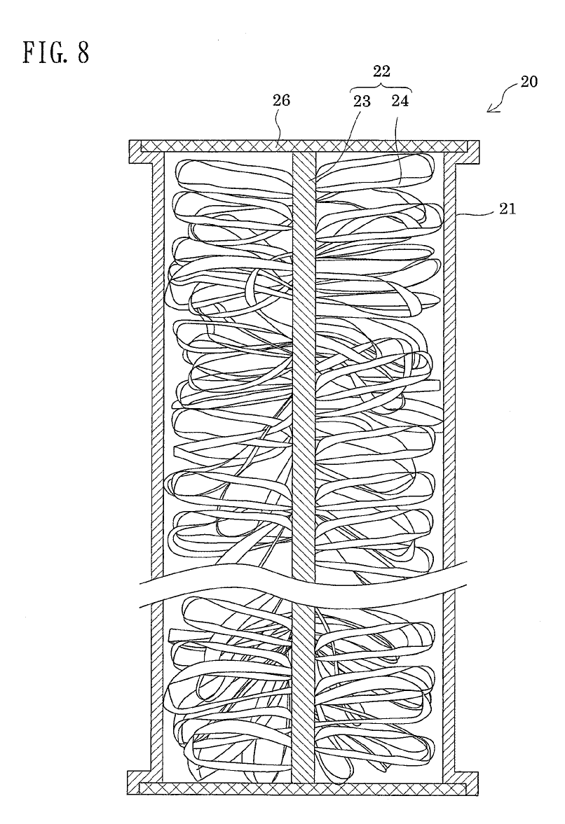

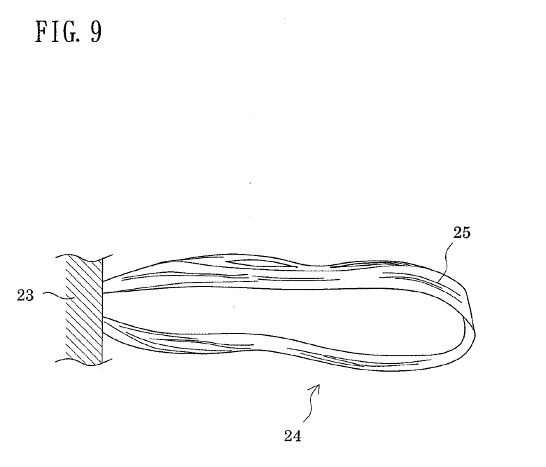

In the present embodiment, the solid-liquid separation means 5 is a filtration means, and has a fibrous filter. For example, it is preferred that a filter having string-shaped (fibrous) suspended matter trapping portions be charged into a filtration tank such that the void content of a filtration portion during water passage is 50 to 95%. A concrete example of such a filtration means is a filtration apparatus shown in FIG. 8. FIG. 8 is a sectional view showing the configuration of the filtration apparatus, and FIG. 9 is an enlarged view of essential parts in FIG. 8.

As shown in FIG. 8, a filtration apparatus 20 has a tubular filtration tank 21 through which water to be treated is passed, and a filter 22 for trapping suspended matter contained in the water to be treated which is being passed. The filter 22 comprises a core material 23 connected to both ends in the direction of water passage of the filtration tank 21, and strip-shaped suspended matter trapping portions 24. Circular plates 26 of resin or the like having a plurality of holes enough for the free passage of water to be treated, which contains flocs formed from the suspended matter or the like, are provided at both ends in the direction of water passage of the filtration tank 21, and both ends of the core material 23 are fixed to the center of each plate 26. The suspended matter trapping portions 24 are partly woven into and fixed to the core material 23, and have so-called looped parts which are unfixed and which are provided so as to spread radially toward the inner wall surface of the filtration tank 21. In this manner, the filter 22 spreads throughout the filtration tank 21. Thus, the suspended matter trapping portions 24 intersect the direction of water passage, so that the suspended matter, etc. contained in the water to be treated can be trapped by the suspended matter trapping portions 24. The string-shaped suspended matter trapping portion 24 is a long rectangular portion (tape) formed into a looped shape, and is provided with a plurality of slits 25 which do not reach the end in the longitudinal direction, as shown in an enlarged view of the string-shaped suspended matter trapping portion 24 as FIG. 9. By providing the slits 25 in such a manner, the effect of trapping the suspended matter, etc. is enhanced.

The filter 22 is charged into the filtration tank 21 such that the void content of a filtration portion when passed through by the water to be treated is 50 to 95%, preferably 60 to 90%, more preferably 50 to 80%. The void content is a value obtained from the equation indicated below. The filtration portion refers to a region where the suspended matter, etc. in the water to be treated are trapped by the filter 22, namely, a region remaining after excluding a part, which does not contribute to filtration (the part corresponding to the core material 23 in FIG. 8), from a layer whose side surface is the inner wall surface of the filtration tank 21, whose opposite ends in the thickness direction are both ends in the direction of water passage of the filter 22 during water passage, and which is filled with the suspended matter trapping portions 24 of the filter 22. If the part not contributing to filtration is absent, the filtration portion refers to the layer whose side surface is the inner wall surface of the filtration tank 21, whose opposite ends in the thickness direction are both ends in the direction of water passage of the filter 22 during water passage, and which is filled with the suspended matter trapping portions 24 of the filter 22. The “volume of filtration portion-volume of suspended matter trapping portions”, in an example such as in FIG. 8 in which the filter 22 is not compacted, but remains charged into the filtration tank 21, during filtration operation (during water passage of the water to be treated) to form the filtration portion at the time of filtration operation, can be easily determined by subtracting the volume of the core material 23 from the amount of the water to be treated which has overflowed when the filter 22 is placed in the filtration tank 21 filled with the water to be treated. In FIG. 8, both ends of the filter 22 are fixed to both ends in the direction of water passage of the filtration tank 21, and the filter 22 spreads in the entire filtration tank 21 during water passage of the water to be treated. Hence, the region remaining after subtracting the part corresponding to the core material 23 from the entire interior of the filtration tank 21 is the filtration portion.

Void content (%)=[(volume of filtration portion−volume of suspended matter trapping portions)/volume of filtration portion]×100 [Equation 1]

When the water to be treated is passed through the filtration apparatus 20 of the above-described configuration, the water to be treated passes through the respective string-shaped suspended matter trapping portions 24 and the slits 25 provided in the suspended matter trapping portions 24. During this course, the suspended matter, etc. contained in the water to be treated are trapped by the string-shaped suspended matter trapping portions 24 and the slits 25, and the water to be treated which has been deprived of the suspended matter is discharged from the filtration tank 21. Since the filter 22 is charged such that the void content of the filtration portion during water passage is 50 to 93%, water passage is not impeded, and the trapping of the suspended matter, etc. is satisfactory. In the present invention, in particular, the water to be treated which is introduced into the filtration apparatus 20 is prevented from involving the destruction of flocs formed from the suspended matter, etc. and the flocculant and coarsened. Thus, the suspended matter, etc. can be trapped satisfactorily by the filtration apparatus 20.

As described above, water passage is not impeded, and the trapping of the suspended matter, etc. is rendered satisfactory, by charging the filter 22 such that the void content of the filtration portion during water passage is 50 to 95%. Thus, the effects are exhibited that clogging of the filtration apparatus 20 can be suppressed, and clear treated water is obtained. If the void content is higher than 95%, water passage becomes satisfactory and fast filtration is easily achieved, but the turbidity of treated water is markedly high. If the void content is lower than 50%, the trapping of the suspended matter is satisfactory, but water passage is so insufficient that clogging occurs in the filtration apparatus or a membrane separation means provided optionally in a subsequent stage, whereupon the rate of increase in the differential pressure becomes markedly high. Particularly when the filtration operation is performed at a high speed of, say, 100 m/h or above, or when the water to be treated which has a high turbidity (e.g., 20 degrees or higher) is treated, the problem tends to occur that the turbidity of resulting treated water rises, or that the apparatus clogs. By using the filtration apparatus 20 charged with the filter 22 such that the void content is 50 to 95%, on the other hand, clogging can be suppressed, and clear treated water is obtained, even in the case of the high speed operation or the highly turbid water to be treated. Even when low speed treatment is carried out or the low turbidity water to be treated is treated, it goes without saying that clogging can be suppressed, and clear treated water is obtained. Since the void content is preferably uniform, it is preferred that the suspended matter trapping portions 24 be charged up to sites near both ends in the water passage direction of the filtration tank 21. It is also preferred that the suspended matter trapping portions 24 be charged up to sites near the inner wall surface of the filtration tank 21. Furthermore, the volume of the filtration portion preferably does not change between states, namely, between the time of water passage of the water to be treated and other state such as the time of backwash to be described later or the time of stoppage of filtration. The change rate of the volume of the filtration portion is preferably 30% or less, more preferably 10% or less. By setting such a range, the filtration apparatus can be rendered compact.

In the filtration apparatus of FIG. 8, the size of the filtration tank 21, if tubular in shape, can be made to have a diameter of 100 to 1,000 mm and a height of 200 to 1,000 mm. If the size of the filtration tank 21 is larger than the size of the filter 22, it is permissible, for example, to charge a plurality of the filters 22 into the filtration tank 21, or upsize the suspended matter trapping portions 24 of the filter 22, thereby adjusting the void content of the filtration portion during water passage to 50 to 95%.

Examples of the material for the core material 23 or the suspended matter trapping portion 24 are synthetic resins such as polypropylene, polyester and nylon. The core material 23 may be given strength by knitting up synthetic fibers, such as polypropylene, polyester or nylon, during the manufacturing process. Alternatively, like a twisted brush, an example may be adopted in which a wire formed from SUS or a resin-coated metal free from corrosion is used as the core material 23, the suspended matter trapping portions 24 are arranged uniformly, and then the metal is twisted to construct the filter 22 having the suspended matter trapping portions 24 spread radially. By so enhancing the strength of the core material 23, the core material 23 does not bend any more, and the ends of the filter 22 are easily fixed thereto. Thus, replacement work for the filter 22 is facilitated.

The sizes of the core material 23 and the suspended matter trapping portion 24 are not restricted. For example, the size can be such that the thickness is 0.05 to 2 mm, the width is 1 to 50 mm, and the length (the distance from the core material when the water to be treated is passed) is of the order of 10 to 500 mm, preferably, the thickness is 0.3 to 2 mm, the width is 1 to 20 mm, and the length is of the order of 50 to 200 mm.

In FIG. 8, the tubular filtration tank 21 is shown. However, the tubular shape is not limitative; a shape which allows water passage, namely, a hollow shape, is acceptable, and a prismatic shape having a hollow inside, for example, may be adopted. In the above example, moreover, both ends of the core material 23 are fixed to the plates 26. However, this is not limitative and, for example, only one end of the core material may be fixed to the plate. Besides, the plates need not be used, as long as the end of the core material 23 can be fixed. For example, a rod-shaped member may be disposed on the end face of the filtration tank 21, and the end of the core material 23 may be fixed thereto.

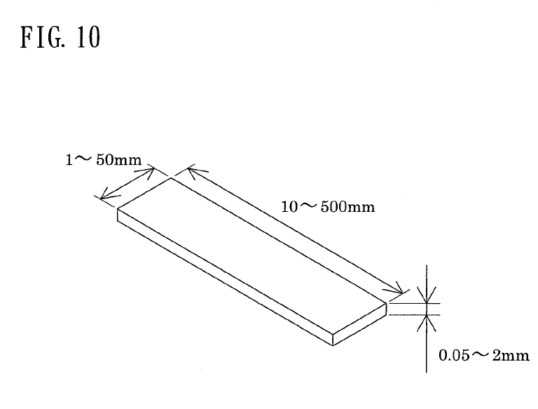

In FIG. 8, the loop-shaped suspended matter trapping portions 24 protrude from the core material 23, but this is not limitative. For example, a plurality of strip-shaped suspended matter trapping portions may be used, as shown in FIG. 10, and one end of each suspended matter trapping portion may be fixed to the core material. In FIG. 8, the cross-sectional shape of the suspended matter trapping portion 24 is quadrilateral, but there are no limitations in this connection, and a circular shape, for example, may be adopted. The length of each suspended matter trapping portion may be the same or different. In the aforementioned example, moreover, the material for the suspended matter trapping portion 24 is of a single type, but two types or more may be used. Furthermore, there may be a plurality of the slits or the single slit provided in the suspended matter trapping portion, or there may be none of the slits provided. The core material 23 may be absent, and the filter 22 may be composed of the suspended matter trapping portions only. Since it is preferred that the filter 22 be present nearly uniformly in the filtration tank 21, however, the suspended matter trapping portions are preferably fixed at a predetermined position in the filtration tank.

By performing such mixing, flocculation and solid-liquid separation, clear treated water is obtained, but there may further be deionization such as ion exchange treatment. By such treatment, pure water or ultrapure water can be obtained. Treatment for purification of the water to be treated, such as decarboxylation or activated carbon treatment, may be further carried out.

If desired, a pH adjustor, a coagulant, a microbicide, a deodorizer, an anti-foaming agent, an anti-corrosive, etc. may be added. Furthermore, ultraviolet irradiation, ozone treatment, or bioremediation may be concurrently used, if desired.

### EXAMPLES

The present invention will now be described in further detail based on Example and Comparative Example, but is in no way limited by these examples.

### Example 1

As water to be treated (raw water), industrial water (turbidity 5 to 7 degrees) was treated by the water treatment apparatus shown in FIG. 5. The water treatment apparatus used will be detailed concretely. The water treatment apparatus has the mixing means 3A composed of two line mixers connected in series, the flocculation means 4 shown in FIG. 2, and the filtration apparatus 20 shown in FIG. 8, these components being arranged in this sequence. As a liquid feeding means, the pump P1 is provided only in the stage preceding the mixing means 3A. In the mixing means 3A and the flocculation means 4, the water to be treated is held unexposed to the atmosphere. The mixing means 3A, the flocculation means 4, and the filtration apparatus 20 are connected in this sequence by piping, and the water to be treated is passed, without being exposed to the atmosphere, from the mixing means 3A as far as the filtration apparatus 20 via the flocculation means 4. The conditions of each treatment means will be described below.

<Mixing Means>

Two line mixers (model 1/2-N50-171-1, produced by NORITAKE CO., LTD.) were connected in series for use as a mixing means. Ahead of the first line mixer in the water passage direction of the water to be treated, polyaluminum chloride (PAC: 10% by weight as Al₂O) was added in an amount of 60 mg/L with respect to the water to be treated. The dwell time in the zone from the outlet of the first line mixer until the inlet of the second line mixer was of the order of 10 seconds. Directly before the second line mixer, an amphoteric polymer flocculant (Kuribest E851, produced by Kurita Water Industries Ltd.) was added in an amount of 4 mg/L with respect to the water to be treated.

<Flocculation Means>

Size of the flocculation tank: Inner diameter 100 mm×height 510 mm

Position of the for-treatment water inlet: The central position of a cross section in the water passage direction thereof was the radius thereof +20 mm upwardly from the bottom of the flocculation tank.

Position of the for-treatment water outlet: The central position of a cross section in the water passage direction thereof was the radius thereof +20 mm downwardly from the ceiling (top surface) of the flocculation tank.

Amount of water passage of the water to be treated: Initial flow velocity (flow velocity at the for-treatment water inlet): 1.33 [m/s]

Dwell time of the water to be treated: 1 minute

Stirring speed (rotational speed of the swirl flow): 20 to 30 rpm

Average G-value of the flocculation tank: 121.07 [l/s]

<Filtration Apparatus>

Size of the filtration tank: Tubular column of acrylic resin with a diameter of 200 mm and a height of 500 mm

Filter: The filter 22 comprising the core material 23 and the string-shaped suspended matter trapping portions 24. The core material had a volume of 250 mL, and each suspended matter trapping portion 24 was woven in a loop form into the core material such that its thickness was 0.5 mm, its width was 2 mm, and its length (distance of its loop end from the core material when the water to be treated was passed) was 100 mm. The void content of the filtration portion (the remainder after subtracting the volume of the core material 23 from the volume of the interior of the filtration tank 21) during water passage was 60%. Both ends of the core material 23 of the filter 22 were fixed to the plates placed above and below.

LV=250 m/h

The diameter of flocs in the flocculation tank, and the turbidities at the inlet and outlet of the filtration apparatus were measured. The results are shown in Table 1. The turbidity decrease rate obtained as (turbidity at inlet of filtration apparatus−turbidity at outlet of filtration apparatus)/turbidity at inlet of filtration apparatus×100, and the time after start of water passage (described as “elapsed time after water passage”) through the filtration apparatus are also shown in Table 1. The turbidity was determined by the transmission/scattering measurement method using a formazin standard solution.

### Comparative Example 1

The same procedure as in Example 1 was performed, except that the flocculation means had a flocculation tank and a stirrer and was configured such that the water to be treated was held exposed to the atmosphere, and that a pump for feeding the water to be treated was provided between the flocculation means and the filtration apparatus. In Comparative Example 1, the dwell time of the flocculation means was 10 minutes, and the stirring speed was 30 rpm.

TABLE 1

| | Dwell | Stirring | | Floc | | Elapsed | Turbidity (NTU) | | |
|---|---|---|---|---|---|---|---|---|---|
| | time in | speed in | | diameter in | | time after | Inlet of | Outlet of | Turbidity |
| | flocculation | flocculation | | flocculation | | water | filtration | filtration | decrease |
| | tank | tank | | tank | | passage | apparatus | apparatus | rate |
| Comp. | 10 min | 30 | rpm | 2 to 3 | mm | 1 min | 5.81 | 5.16 | 11.2% |
| Ex. 1 | | | | | | 15 min | 5.51 | 4.24 | 23.0% |
| Ex. 1 | 1 min | 20 to 30 | rpm | 0.5 to 3 | mm | 1 min | 6.48 | 1.55 | 76.1% |

| | | | |
|---|---|---|---|
| 15 min | 6.38 | 1.70 | 73.4% |

As shown in Table 1, the floc diameter in the flocculation tank was nearly comparable in Example 1 and Comparative Example 1, but treated water discharged from the filtration apparatus was much clearer in Example 1 than in Comparative Example 1. In Example 1, it is presumed that flocs were coarsened in the flocculation tank, and these coarse flocks were introduced into the filtration apparatus without being destroyed by the pump or the like, with the result that very clear water as compared with Comparative Example 1 was obtained. In Comparative Example 1 in which the pump for liquid feeding needed to be provided between the flocculation tank and the filtration apparatus, on the other hand, it is presumed that water to be treated which was introduced into the filtration apparatus underwent destruction of flocs, thereby forming fine flocs, which could not be trapped by the filtration apparatus.

Reference example showing the effects of the filtration apparatus 20 will be indicated below.

(Relation between the void content and the increase in the differential pressure as well as the turbidity of treated water in the filtration apparatus)

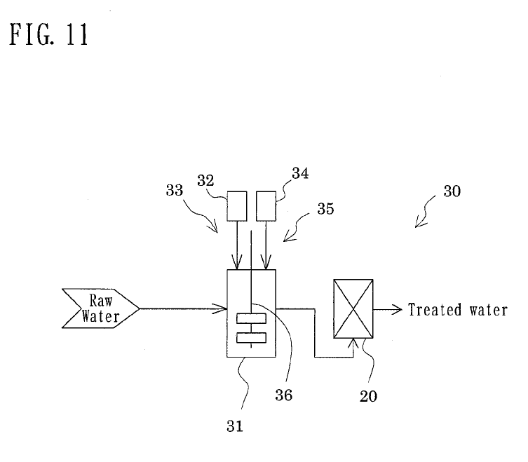

As water to be treated (raw water), industrial water having turbidity of 20 degrees was treated for a week at LV 200 m/h by use of the water treatment apparatus 30 shown in FIG. 11. The water treatment apparatus 30, as shown in FIG. 11, had a reaction tank 31 into which water to be treated (raw water) was introduced; an inorganic flocculant introduction means 33 composed of a pump or the like for introducing an inorganic flocculant into the reaction tank 31 from an inorganic flocculant tank 32 holding the inorganic flocculant; a chemical introduction means 35 composed of a pump or the like for introducing a chemical into the reaction tank 31 from a chemical tank 34 holding a polymer flocculant; and the filtration apparatus 20 of FIG. 8 into which the water to be treated was introduced, the water having been subjected to flocculation by being stirred by a stirrer 36 in the reaction tank 31. The filter used in the filtration apparatus 20 comprised the core material 23 and the string-shaped suspended matter trapping portions 24, and both ends of these components were fixed to the plates 26 disposed at both ends in the water passage direction of the filtration tank 21, as shown in FIG. 8. The core material 23 had a volume of 250 mL, and each suspended matter trapping portion 24 was woven in a loop form into the core material such that its thickness was 0.5 mm, its width was 2 mm, and its length (distance of its loop end from the core material when the water to be treated was passed) was 100 mm. The filter was prepared, with the weaving density of the suspended matter trapping portion 24 being varied, such that the void contents of the filtration portion (the remainder after subtracting the volume of the core material 23 from the volume of the interior of the filtration tank 21) during water passage were 30, 40, 50, 60, 70, 80, 90, 95 and 98%. Water treatment was performed using each of the resulting filters. Since the core material was fixed at both ends, the change rate of the volume of the filtration portion was nearly 0% when the volume during passage of the water to be treated and the volume on other occasion were compared. The size of the filtration tank 21 was such that its diameter was 200 mm and its height was 500 mm. As a flocculant, 30 mg/L, with respect to the water to be treated, of polyaluminum chloride (PAC: 10% by weight, as Al₂O₃) and 0.7 mg/L, with respect to the water to be treated, of Kuribest E851 (produced by Kurita Water Industries Ltd.) as an amphoteric polymer flocculant were added. The turbidity of treated water discharged from the filtration apparatus (treated water turbidity), and the rate of increase in the differential pressure of the filtration apparatus (differential pressure increase rate) were measured, and the results are shown in Table 2. The turbidity of the treated water was determined by the transmitted light measuring method using a kaolin standard solution, and the differential pressure increase rate of the filtration apparatus was determined by the pressure difference between the inlet and the outlet.

It was found that with the filtration apparatus having the filter charged such that the void content of the filtration portion during water passage would become 50 to 95%, the differential pressure increase rate and the treated water turbidity were markedly low as compared with that having avoid content outside the range of 50 to 95%, clear treated water was obtained, and clogging could be suppressed.

TABLE 2

Filter comprising core material and string-shaped
suspended matter trapping portions

| | Differential pressure | |
|---|---|---|
| Void | increase rate | Treated water turbidity |
| content % | (kPa/D) | (degrees) |
| 98 | 0 | 16 |
| 95 | 0 | 3.7 |
| 90 | 0 | 3 |
| 80 | 0 | 2.2 |
| 70 | 0.1 | 1.1 |
| 60 | 0.1 | 1.1 |
| 50 | 2 | 0.9 |
| 40 | 19 | 0.8 |
| 30 | 50 | 0.4 |

### EXPLANATIONS OF LETTERS OR NUMERALS

1 Water treatment apparatus, 2 Raw water tank, 3 Mixing means, 4 Flocculation means, 5 Solid-liquid separation means, Flocculant introduction means, 7 PH adjustor introduction means, 11 Flocculation tank, 12 For-treatment water inlet, 13 For-treatment water outlet, 16 Mixing tank, 17 Stirrer, 20 Filtration apparatus, 21 Filtration tank, 22 Filter, 23 Core material, 24 Suspended matter trapping portion, 26 Plate

1. A water treatment apparatus, comprising:
mixing means having a mixing tank in which water to be treated is mixed with a flocculant added thereto to form flocs;
flocculation means having a cylindrical flocculation tank into which the water to be treated after discharge from the mixing means is introduced, and in which the water to be treated is kept unexposed to an atmosphere, a for-treatment water inlet which introduces the water to be treated into the flocculation tank from a lower part of the flocculation tank in a tangential direction so as to produce a swirl flow, and a for-treatment water outlet, provided in an upper part of the flocculation tank, for discharging the water to be treated from the upper part of the flocculation tank; and
solid-liquid separation means into which the water to be treated after discharge from the flocculation means is introduced from the flocculation means without being exposed to the atmosphere, and in which the water to be treated is subjected to solid-liquid separation,
wherein the solid-liquid separation means is filtration means comprising a filter charged into a filtration tank such that a void content of a filtration portion during water passage becomes 50 to 95%, the filter having string-shaped suspended matter trapping portions.

2. The water treatment apparatus according to claim 1, wherein the for-treatment water outlet is provided so as to discharge the water to be treated from the upper part of the flocculation tank in a tangential direction.

3. (canceled)

4. The water treatment apparatus according to claim 1, wherein the mixing means keeps the water to be treated in such a state as not to be exposed to the atmosphere, the water to be treated is introduced from the mixing means into the flocculation means without being exposed to the atmosphere, and liquid feeding means for feeding the water to be treated is provided in a stage preceding the mixing means.

5. The water treatment apparatus according to claim 2, wherein the mixing means keeps the water to be treated in such a state as not to be exposed to the atmosphere, the water to be treated is introduced from the mixing means into the flocculation means without being exposed to the atmosphere, and liquid feeding means for feeding the water to be treated is provided in a stage preceding the mixing means.
